(19) United States
(12) Patent Application Publication
(10) Pub. No.: US 2017/0323302 A1
(43) Pub. Date: Nov. 9, 2017

(54) SECURITY SYSTEMS AND METHODS

(71) Applicant: Neil LE VALLEE, St Peter Port, Guernsey (GB)

(72) Inventor: Neil LE VALLEE, St. Peter Port (GG)

(21) Appl. No.: 14/784,442

(22) PCT Filed: Apr. 17, 2014
(86) PCT No.: PCT/GB2014/051230

§ 371 Date: Oct. 14, 2015

(30) Foreign Application Priority Data
Apr. 19, 2013 (GB) 1307154.3

(51) Int. Cl. G06Q 20/40; G06Q 20/42; G06Q 20/32

(52) U.S. Cl. CPC G06Q 20/40975; G06Q 20/425; G06Q 20/32; G06Q 20/4012; G06Q 20/40145

(57) ABSTRACT

A personal wireless communication device (PWD) has a data store that stores a first unique code. A registration database, remote from the PWD, receives and stores the first code. The registration database transmits to the PWD a second unique code that is stored in the PWD. A data reader at the PWD reads a third unique code that is carried on a payment card to be authenticated. A code generator at the PWD generates a fourth unique code in response to user input at the PWD. A code generator at the PWD generates a unique encryption key utilising the first, second, third and fourth codes. The PWD encrypts a unique authorisation code using the unique encryption key that it has generated and transmit the encrypted authorisation code to the remote registration database, which decrypts the authorisation code to authenticate the payment card by reference to the authorisation code. Once authenticated, the owner of the PWD transmits authorisation data to a retailer at location C, who in turn sends the authorisation data to the registration database for confirmation, upon receipt of which a transaction can be completed.

The present invention relates to security systems and methods of operating the same.

Credit cards and other payment cards are used widely for payment these days, especially for purchases made remotely. Where the customer is not present, all of the security data has to be given over the telephone or online Unsurprisingly, this leads to a high level of fraud.

Preferred embodiments of the present invention aim to provide improved security devices and methods of operating the same that provide a higher level of security for remote authentication processes. Such processes may include, for example, payment card purchases made over the telephone or online where the customer is not present.

For ease of reference, the term ‘payment card’ is used in this specification as a generic term to include conventional credit cards, debit cards, store cards and the like that are in widespread use at the present time and typically comprise a small plastics card that carries a magnetic stripe and/or a small semiconductor chip, in which data is encoded and stored. Other technology is also used such as, for example, near field detection, where a card interacts with a reader without necessarily touching it. From a technical point of view, data can be encoded and stored in other portable devices or tokens of various shapes, all of which are included in the term ‘payment card’ for the purposes of this specification.

According to one aspect of the present invention, there is provided a method of authenticating a payment card, between a user of the card and a remote registration location, the method comprising the steps of:

registering at the remote registration location a first unique code of a personal wireless device that is carried by the user;

transmitting a second unique code from the remote registration location to the personal wireless device and storing said second unique code at the personal wireless device;

reading, by means of the personal wireless device, a third unique code that is carried on the payment card;

generating a fourth unique code by user input at the personal wireless device;

generating a unique encryption key at the personal wireless device, utilising said first, second, third and fourth codes;

encrypting a unique authorisation code at the personal wireless device using said unique encryption key;

transmitting the encrypted authorisation code from the personal wireless device to the remote registration location;

decrypting the authorisation code at the remote registration location; and

authenticating the payment card at the remote registration location by said unique authorisation code.

Preferably, said personal wireless device comprises a first component for wireless communication and a second component for reading said card, said components being discrete but interconnected.

Preferably, said personal wireless device comprises a first component for wireless communication and a second component for reading said card, both of said components being integrated within the personal wireless device.

Preferably, said payment card is a credit card, debit card or the like, carrying said third code as magnetically and/or electronically encoded data.

Preferably, said personal wireless communication device comprises a mobile phone that is identified uniquely by said first code.

Preferably, a method according to any of the preceding aspects of the invention further comprises the step of storing authentication data at the registration location upon receipt of said unique authentication code and making the authentication data available to a supplier of goods or services, with whom the user of the card is conducting a transaction.

Said authentication data may be made available to said supplier via a secure login procedure at said registration location.

Preferably, encryption data is transmitted from the registration location to the personal wireless device, which uses the encryption data to encrypt data for transmission from the personal wireless device to the registration location.

Said user input at the personal wireless device, for generating said fourth unique code, may comprise a user PIN.

Said user input at the personal wireless device, for generating said fourth unique code, may comprise biometric data of the user.

Preferably, said authorisation code is partially encrypted at the personal wireless device using said unique encryption key and partially encrypted at the personal wireless device using a standard encryption key that is shared by a plurality of other personal wireless devices.

According to another aspect of the present invention, there is provided a system for authenticating a payment card, the system comprising:

a personal wireless communication device having a data store that stores a first unique code;

a registration database that is remote from the personal wireless device, receives said first unique code from the personal wireless device and stores said first unique code;

a transmitter at said registration database that transmits to said personal wireless device a second unique code that is stored in said data store at the personal wireless device;

a data reader at the personal wireless device that reads a third unique code that is carried on a payment card to be authenticated;

a code generator at the personal wireless device that generates a fourth unique code in response to user input at the personal wireless device; and

a code generator at the personal wireless device that generates a unique encryption key utilising said first, second, third and fourth codes;

the personal wireless device being arranged to encrypt a unique authorisation code using said unique encryption key and transmit the encrypted authorisation code to the remote registration database; and

the remote registration database being operative to decrypt the authorisation code and authenticate the payment card by reference to the authorisation code.

Preferably, such a system is arranged to carry out a method according to any of the preceding aspects of the invention.

For a better understanding of the invention, and to show how embodiments of the same may be carried into effect, reference will now be made, by way of example, to the accompanying diagrammatic drawings, in which:

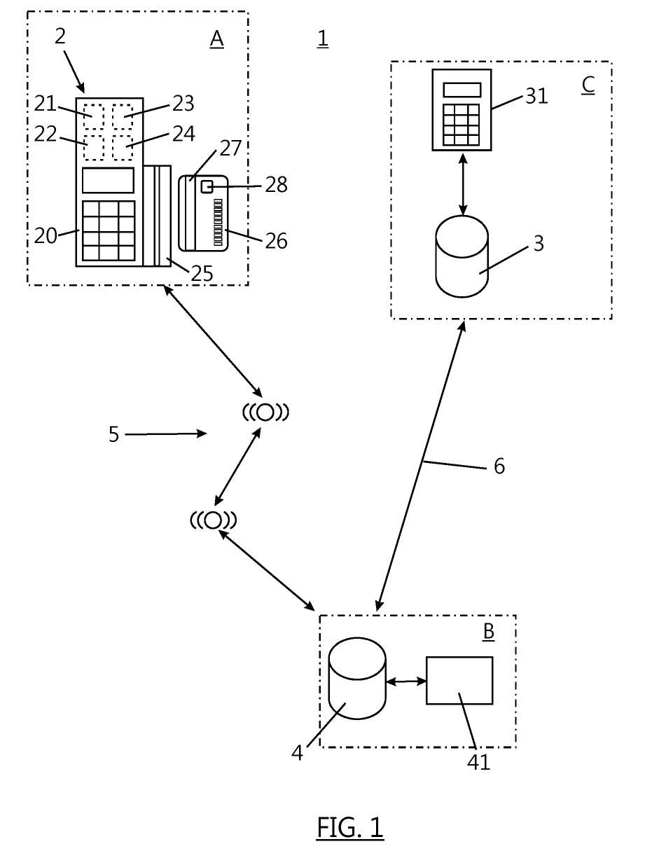

FIG. 1 is a block diagram to illustrate one example of a system and method for authenticating a remote process;

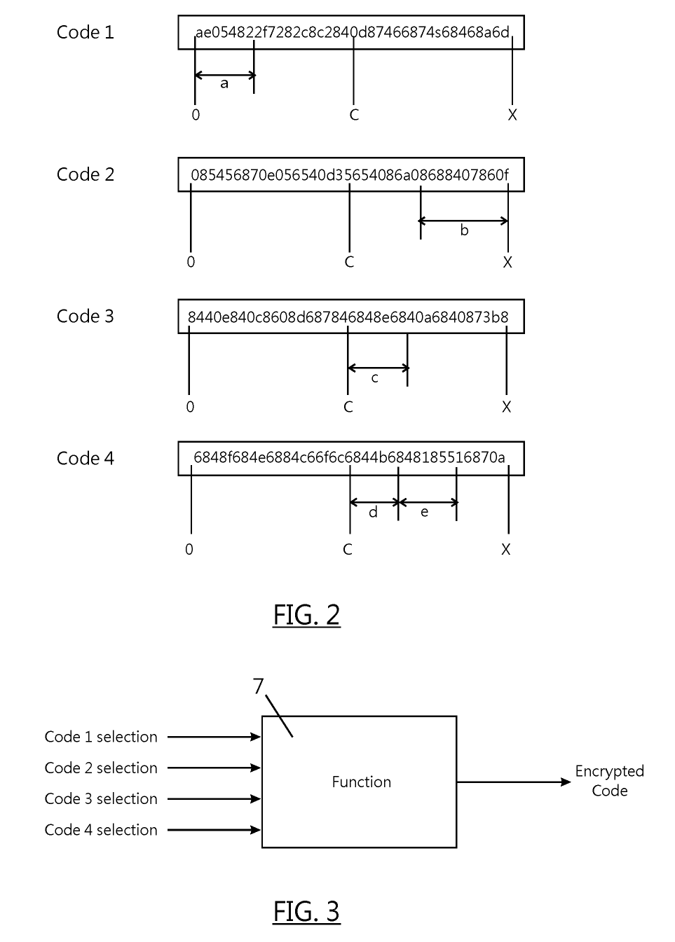

FIG. 2 illustrates data selection from four different codes; and

FIG. 3 illustrates formation of an encryption key from selected data.

The example system 1 that is illustrated in FIG. 1 is distributed over a user location A, a registration location B and a retail (or other) location C. Locations A and B communicate with each other over a wireless network 5. Locations B and C communicate with each other over a link 6 that may be wireless or a hard connection 6 such as the Internet, a landline, etc. Locations A and C may communicate with each other in any convenient way—e.g. wireless or landline telephone connection, Internet, etc.

At the user location A, a user has a personal wireless device (PWD) 2 that, in this example, is made up of a mobile (cell) phone 20 that provides wireless communication with the registration location B, and a card reader 25 that is arranged to read data stored on a payment card 26—for example, by way of a magnetic stripe 27 and/or a chip 28. Other card reading technology may be employed—for example, near field detection. The phone 20 and card reader 25 may be discrete devices that are interconnected (hard wired or wireless), or they may be integrated into a single PWD 2.

At the registration location B, one or more registration database 4 is controlled by a control device 41 that is arranged to perform an authentication operation.

At the retail location C, a retail database 3 is connected to a payment card machine 31. Although the retail database 3 and payment card machine 31 are shown at the same retail location C, they could alternatively be at different physical locations and operatively connected to one another by wireless or hard wired means. For example, the retail database 3 may service a number of payment card machines 31 in one or several locations. For smaller retail locations the payment card machine 31 could also communicate directly with the registration location B (not through a retail database 3).

The registration database 4 could be owned and operated by an independent organisation or by a financial services provider (e.g. the payment card provider) and provides a means of authenticating transactions between user location A and retail location C, without direct transmission of sensitive data between user and retailer.

The mobile phone 20 contains a SIM card 21 and, as is customary, the mobile phone 20 has a unique code by which it is identified (often referred to as an IMEI code). The phone 20 has within it a store 22, a code generator 23 and a transmitter 24.

In the example that follows, the owner of the PWD 2 has registered with the owner of the registration database 4 for the provision of financial services—in this example, use of a payment card with the facility of remote authorisation by use of the PWD 2. The owner of the registration database 4 may provide both authorisation and payment via the card, or just authorisation.

In a first step of establishing a security system for such transactions, the PWD 2 is registered with the registration database 4, an example of which is as follows.

A. Registering the PWD 2 with the registration database 4
1. The PWD 2 has a unique device code—for example, a serial number or IMEI—that is stored by the PWD.
2. The PWD 2 also contains application data by which processes in the PWD are controlled. The application is for the purpose of enabling transaction authorisations with a financial services provider. The application need not be provided by the financial services provider; it may be provided by a third party. Use of the application on the PWD is licensed. To this end, the application data includes a license code that, together with the PWD device code, is stored in the store 22. The device code and the license code together (either all or in part) make up a unique identifying code of the PWD 2, which is referred to as a ‘first code’ in this description.
3. A payment card 26 is presented to the PWD 2, and read by the card reader 25.
4. If the PWD 2 has not been previously registered with the registration database 4, the PWD 2 displays on display 29 a request to the user to initiate registration. The user may then accept or reject the registration request.
5. When the user accepts the registration request, the PWD 2 displays a request to the user to enter personal data. This will typically be a username and password that has been provided to the user by the financial services provider, in order to use the service for which registration is being requested. The personal data is stored in the store 22.
6. The PWD 2 then transmits the personal data entered by the user to the registration location B as a registration request, together with the above-mentioned first code of the PWD 2 (derived from its unique device code and application license code). The transmission is over the wireless network 5, via a predetermined number that is stored in the PWD 2 and is provided with the licensed application. (The wireless network 5 may include the Internet and the predetermined number may include a specific URL address, port number, etc.)
7. At the registration location B, the registration database 4 receives the registration request from the PWD 2, checks all of the data received and stores it in a registration section of the database 4.
8. Data checks made at the registration database 4 may include: was the request received on the correct predetermined number; is the PWD device code unique; is the license code both valid and unique; is the username acceptable; is the password acceptable? If any of the data checks fails, a message is sent to the user who is then prompted to re-enter data if possible, or an error message is generated.
9. From the data that it has received, and following successful data checks, the registration database 4 creates a registration code that is unique to the PWD 2 and transmits that code to the PWD 2. The registration code is referred to as a ‘second code’ in this description. It may be generated at the registration database 4 in any desired manner; it may or may not use all or part of the data received so far at the registration database 4.
10. So far, the communication between the user location A and registration location B may be by regular wireless connection—e.g. GSM, wifi with a layer of encryption, etc.
11. The PWD 2 stores its unique registration code in store 22 for future use, when registering payment cards and when requesting transaction authentication (as will be described below).
12. The PWD 2 sends a predetermined test message to the registration database 4 to confirm receipt of its unique registration code. The test message may be generated from the first and second codes, which are known to both the PWD 2 and the registration database 4, using an encryption algorithm that has been determined at the registration database and sent to the PWD 2 with its registration code.
13. The registration database 4 checks the test message sent from the PWD 2, as both the test message and the encryption algorithm are known at the registration database 4.
14. Upon the test message checking satisfactorily, the registration database 4 sends a ‘registration complete’ message back to the PWD 2, using any level of encryption (or none). If the test message does not check satisfactorily, the registration procedure terminates, and can be attempted again.
15. Upon receiving the ‘registration complete’ message, the PWD 2 sets a flag (e.g. by recording a registration date and time) to confirm completion of registration and closes the registration procedure.
16. The PWD 2 is now ready for use for authorisation of financial transactions.

Once the PWD 2 itself is registered with the registration database 4 as described above, the next step is to register one or more payment card with the registration database 4. An example of this is as follows.

B. Registering a Payment Card
1. When a card 26 is presented to the PWD 2, the PWD 2 automatically reads data encoded on the card 26—e.g. by way of a magnetic stripe, a chip, near field detection, etc. The card data is referred to as a ‘third code’ in this description. It may typically be a number as printed on the card 26, but could be any other data carried by the card.
2. The PWD 2 then checks whether it already holds registration data of that particular card 26.
3. If it does not already hold registration data, the PWD 2 starts a card registration procedure.
4. In the card registration procedure, the PWD 2 displays a request to the user to enter user data. The user data may be a PIN or any other identifier (e.g. biometric data, fingerprint, face or iris recognition, etc.) that the user chooses at this point to use with the card. 26. The user data is referred to as a ‘fourth code’ in this description. For security reasons, it is not stored in the PWD 2.
5. The PWD 2 then transmits a card registration request to the registration location B, together with the third and fourth codes, encrypted by the previously mentioned algorithm as used for registration of the PWD 2, via another predetermined number (different from that used for the PWD registration) that is stored in the PWD 2. The PWD 2 may receive the predetermined card registration call number with the initial application data, or it may be provided by the registration database 4 as part of the device registration procedure for the PWD 2.
6. At the registration location B, the registration database 4 receives the card registration request, checks that it was received on the correct predetermined number, decrypts the encrypted data and checks that it is a genuine request—for example, the encryption algorithm may include predetermined strings at the start and the end of the encrypted data.
7. The registration database 4 checks the new card registration data against its record of registered cards, to ensure that the card 26 has not already been registered.
8. If the card 26 has already been registered, the registration database 4 sends a message to the PWD owned by the original registrant, to inform them that another person is trying to register their card.
9. If the card 26 has not already been registered, the registration database 4 sends unique card registration information to the PWD 2—which information contains special encryption instructions, including which parts of the first to fourth codes to use for subsequent encryptions. The card registration information also includes instructions on which number the PWD 2 should use for future calls for that particular card—the registration database 4 having many numbers on which calls can be received.
10. Using the assigned number to call and using the assigned special encryption instructions, the PWD 2 sends a predetermined test message to the registration database 4.
11. The registration database 4 checks the test message sent from the PWD 2, using the known encryption algorithm
12. Upon the test message checking satisfactorily, the registration database 4 stores the card data in a card registration file, links the card data to the PWD 2 data, and stores decryption information for the card in a separate area of the database, for security. If the test message does not check satisfactorily, the registration procedure terminates, and can be attempted again.
13. Upon completion of its data storage procedures, the registration database 4 sends a ‘registration complete’ message back to the PWD 2.
14. Upon receiving the ‘registration complete’ message, the PWD 2 sets a flag to confirm completion of card registration and closes the registration procedure. In this case, the flag may include a future date by which the card must be re-registered. For example, the card may require registration annually (or at any other interval).
15. The registered card 26 is now ready for use with the PWD 2.

There now follows an example of how the PWD 2 and registered card 26 may be used to authorise a remote payment card payment, using a user-selected PIN to identify the card holder
1. The user, as a customer, calls a retailer to make a purchase and, in addition to providing the usual customer information such as name and address, provides basic details of the card that is to be used to pay for the goods or service. The type of card and its (typically) 16-digit number may be sufficient, as the authorisation system provides enhanced security.
2. The user presents the required payment card 26 to the PWD 2, which firstly checks if the card is already registered with the PWD 2. The following assumes that the card 26 is registered. If not, a card registration procedure as described above may be followed.
3. The PWD 2 requests the price for the purchase to be entered along with other relevant information (e.g. a transaction ID as provided by the retailer) and displays a request for the user to enter the previously selected personal PIN via the keypad 20 (or other personal identifier that is entered by appropriate means, corresponding to the above-mentioned fourth code).
4. The PWD 2 then automatically adds card details and ownership confirmation details as stored on the PWD 2.
5. From the above details relating to the card and the purchase, which may be combined in many different ways, the PWD 2 constructs an authorisation code for the transaction using a specialised application built into the PWD 2 and adds it to an authentication file, which maintains a historical record of authorisations.
6. The PWD 2 encrypts the authorisation code to be sent to database 4, along with the transaction data that has been used to generate the authorisation code.
   (a) Part 1: The PWD 2 uses a standard encryption key that was provided by database 4 to encrypt a first part of the authorisation code, which may include a sequential number of the card being used and other information relating to the card and/or transaction (various cards registered via the PWD 2 may be given a sequential number 1, 2, 3) . . . ).
   (b) Part 2: The PWD 2 uses an encryption key that is unique to the payment card 26 and constructed from the first to fourth codes to encrypt the remaining, second part of the authorisation code.
7. The PWD 2 then transmits the encrypted authorisation code to the registration database 4 on the predetermined number that has been allocated to that card 26.
8. At the registration database 4, the first part of the authorisation code including the identity of the PWD 2 and the card 26 in use are firstly decrypted, using the standard decryption key—for example, the serial number of the PWD 2 and the sequential number of the card in use may be decrypted.
9. The registration database 4 then decrypts the remaining part of the authorisation code using the unique encryption key and makes checks for consistency that it has been sent by the authorised user.
10. When the authorised user is confirmed, the registration database 4 generates its own version of the authorisation code from its own data and the transaction data that was transmitted from the PWD 2 along with the authorisation code; checks that its self-generated authorisation code matches the authorisation code sent by the PWD 2; and when confirmed it returns a confirmation to the authorised user's PWD 2 and posts an entry on a cleared transaction file for the retailer to check.
11. The PWD 2 on receipt of the confirmation stores authorisation data and ends the authorisation procedure at the user's side as successful.
12. The authorisation data is transmitted to the retailer by the user. This can be orally over the telephone or electronically.
13. The retailer sends a request to the registration database 4 cleared transaction file to confirm authorisation for the purchase, using the authorisation data received from the user. This can be immediate—the authorisation may remain accessible for a predetermined time.
14. The registration database 4 sends or returns confirmation to the retailer that the purchase request has come from the authorised card user.
15. Following authentication of the identity of the card user, the retailer obtains authorisation for the amount to be charged. This may be in a more or less conventional manner—the operator of location B does not have to be the payment card issuer. Or the authentication of identity and authorisation for the amount charged may be combined in a single operation—the operator of location B may be the payment card issuer.
16. The retailer completes the purchase transaction.

In order to use the system, the retailer at C (or their payment agent) registers with the database owner B, and is given unique login credentials.

It may be noted that the principal purpose of the authorisation operation that has just been described is to ensure that the customer is indeed the authorised user of the card. Once that has been established, approval for payment of the requested sum by the payment card issuer is a relatively straightforward matter.

The aforementioned authorisation code may be constructed in many different ways—it may include all or parts of data relating to date, price, transaction ID, etc.

The aforementioned standard encryption key may be common to all devices that are registered with the registration database. The aforementioned unique encryption key is unique to the particular PWD 2 and payment card 26, but is known to the registration database 4.

FIGS. 2 and 3 illustrate a method by which a unique encryption key may be constructed and used for encryption.

In FIG. 2, Code 1 is unique data from the PWD 2—e.g. serial number, number of a SIM card within it, etc. Code 2 is the registration code received by the PWD 2 from the registration database 4. Code 3 is data from the payment card 26. Code 4 is a PIN, password or other data input by a user at the PWD 2.

In this example, Codes 1 to 4 are conveniently represented in hexadecimal format—but they could be in any other format, such as binary The codes are shown of equal length, but they may typically be of differing lengths. Markers O, C and X indicate start, centre and end positions of each code, respectively.

The encryption key utilises the first ‘a’ bytes of Code 1, the last ‘b’ bytes of Code 2, the first ‘c’ bytes of Code 3 after the centre position C, and ‘e’ bytes of Code 4, offset by ‘d’ bytes from the centre position C. The data bytes that are utilised may be concatenated together in a predetermined order—e.g. in the order Code 3, Code 2, Code 4, Code 1.

It will be appreciated that, by varying the values a, b, c, d and e, and the order of the codes, unique combinations of bytes may be obtained. The byte selection of each code may be derived from an origin value (e.g. O, C, X), a positive or negative offset value, and a number value (number of bytes selected). Therefore, the byte selections may be expressed in various different ways. Depending upon the length of the code, origin, offset and number values for one code may be derived from specified bytes of another one of the codes. Instead of simply concatenating selected bytes from each code, the bytes may be related by a more complex function, including mutual multiplication, division and any other practical function.

FIG. 3 illustrates the selected bytes from Codes 1 to 4, passed to a processor 7 that performs a predetermined function on the authorisation code, to provide the encrypted authorisation code as output. By varying both the selection of data from Codes 1 to 4 and the nature of the predetermined function of the processor 7, limitless encryption processes may be obtained.

Methods and systems as illustrated and/or as described above may be implemented on existing mobile phones (e.g. those incorporating near field detection technology) by the addition of application software. A personal wireless device (such as the PWD 2) could be a wireless device other than a mobile phone.

In this specification, the verb “comprise” has its normal dictionary meaning, to denote non-exclusive inclusion. That is, use of the word “comprise” (or any of its derivatives) to include one feature or more, does not exclude the possibility of also including further features.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of authenticating a payment card, between a user of the card and a remote registration location, the method comprising the steps of:
registering at the remote registration location a first unique code of a personal wireless device that is carried by the user;
transmitting a second unique code from the remote registration location to the personal wireless device and storing said second unique code at the personal wireless device;
reading, by means of the personal wireless device, a third unique code that is carried on the payment card;
generating a fourth unique code by user input at the personal wireless device;
generating a unique encryption key at the personal wireless device, utilising said first, second, third and fourth codes;
encrypting a unique authorisation code at the personal wireless device using said unique encryption key;
transmitting the encrypted authorisation code from the personal wireless device to the remote registration location;
decrypting the authorisation code at the remote registration location; and
authenticating the payment card at the remote registration location by said unique authorisation code.

2. A method according to claim 1, wherein said personal wireless device comprises a first component for wireless communication and a second component for reading said card, said components being discrete but interconnected.

3. A method according to claim 1, wherein said personal wireless device comprises a first component for wireless communication and a second component for reading said card, both of said components being integrated within the personal wireless device.

4. A method according to claim 1, wherein said payment card is a credit card, debit card or the like, carrying said third code as magnetically and/or electronically encoded data.

5. A method according to claim 1, wherein said personal wireless communication device comprises a mobile phone that is identified uniquely by said first code.

6. A method according to claim 1, further comprising the step of storing authentication data at the registration location upon receipt of said unique authentication code and making the authentication data available to a supplier of goods or services, with whom the user of the card is conducting a transaction.

7. A method according to claim 6, wherein said authentication data is made available to said supplier via a secure login procedure at said registration location.

8. A method according to claim 1, wherein encryption data is transmitted from the registration location to the personal wireless device, which uses the encryption data to encrypt data for transmission from the personal wireless device to the registration location.

9. A method according to claim 1, wherein said user input at the personal wireless device, for generating said fourth unique code, comprises a user PIN.

10. A method according to claim 1, wherein said user input at the personal wireless device, for generating said fourth unique code, comprises biometric data of the user.

11. A method according to claim 1, wherein said authorisation code is partially encrypted at the personal wireless device using said unique encryption key and partially encrypted at the personal wireless device using a standard encryption key that is shared by a plurality of other personal wireless devices.

12. (canceled)

13. A system for authenticating a payment card, the system comprising:
a personal wireless communication device having a data store that stores a first unique code;
a registration database that is remote from the personal wireless device, receives said first unique code from the personal wireless device and stores said first unique code;
a transmitter at said registration database that transmits to said personal wireless device a second unique code that is stored in said data store at the personal wireless device;
a data reader at the personal wireless device that reads a third unique code that is carried on a payment card to be authenticated;
a code generator at the personal wireless device that generates a fourth unique code in response to user input at the personal wireless device; and
a code generator at the personal wireless device that generates a unique encryption key utilising said first, second, third and fourth codes;
the personal wireless device being arranged to encrypt a unique authorisation code using said unique encryption key and transmit the encrypted authorisation code to the remote registration database; and
the remote registration database being operative to decrypt the authorisation code and authenticate the payment card by reference to the authorisation code.

14. (canceled)

15. (canceled)
